(19) United States
(12) Patent Application Publication
(10) Pub. No.: US 2010/0321274 A1
(43) Pub. Date: Dec. 23, 2010

(54) Multiple frequency antenna assembly

(75) Inventor: Huei Chi Wu, Tauyuan Hsien (TW)

Correspondence Address: CHARLES E. BAXLEY, ESQUIRE, 90 JOHN STREET, SUITE 403, NEW YORK, NY, 10038, US

(73) Assignee: Joymax Electronics Co., Ltd.

(21) Appl. No.: 12/456,531

(22) Filed: Jun. 17, 2009

(51) Int. Cl. H01Q 21/00; H01Q 1/38

(52) U.S. Cl. 343/893; 343/700 MS

(57) ABSTRACT

An antenna assembly includes a circuit board, a substrate extended from one side of the circuit board, a conductive member provided the other side of the circuit board, and a GPS antenna connected to the conductive member and arranged opposite to the second side of the substrate, one or more antenna devices and a GSM antenna are disposed on the circuit board and arranged opposite to the GPS antenna for preventing the GPS antenna and the antenna devices and the GSM antenna from being interfered or affected by each other and for allowing the antenna assembly to suitably transmit and receive the signals.

### BACKGROUND OF THE INVENTION

1. Field of the Invention

The present invention relates to an antenna assembly, and more particularly to a multiple frequency antenna assembly including a structure for allowing the antenna assembly to suitably transmit and receive the signals and for increasing the gain of the antenna assembly.

2. Description of the Prior Art

Typical antenna devices comprise one or more antenna conductors or conductive branches each having one or more feeds extended therefrom, and the conductive branches are in adjacent, spaced-apart relationship for transmitting or receiving waves or signals and for allowing the radiators to transmit or to receive waves or signals or different resonant frequencies.

For example, U.S. Pat. No. 6,529,749 to Hayes et al., and U.S. Pat. No. 6,542,126 to Bahr et al. disclose two of the typical compact antenna devices each comprising one or more antenna conductors or conductive branches provided for use within wireless communication devices, such as radiotelephones, and for jointly radiating as a dipole antenna.

However, the antenna conductors or the conductive branches are disposed parallel to a ground plane such that the signal transmitting and receiving functions of the conductive branches are limited.

U.S. Pat. No. 6,570,538 to Vaisanen et al., U.S. Pat. No. 6,606,250 to Shi, and U.S. Pat. No. 6,861,986 to Fang et al. disclose three further typical multiple frequency antenna devices each comprising one or more antenna conductors or radiating elements having opposite ends and a grounding element spaced apart from the radiating elements.

However, similarly, the antenna conductor or radiating elements are also disposed parallel to the ground plane such that the signal transmitting and receiving functions of the conductive branches are limited.

The present invention has arisen to mitigate and/or obviate the afore-described disadvantages of the conventional antenna members or devices.

### SUMMARY OF THE INVENTION

The primary objective of the present invention is to provide an antenna assembly including a structure for allowing the antenna assembly to suitably transmit and receive the signals and for increasing the gain of the antenna assembly.

In accordance with one aspect of the invention, there is provided an antenna assembly comprising a circuit board including two opposite sides, such as including a first side and a second side, a substrate extended from the second side of the circuit board, a conductive member provided the first side of the circuit board, and a global position system (GPS) antenna connected to the conductive member of the circuit board and arranged opposite to the second side of the circuit board and the substrate, or the circuit board is disposed between the GPS antenna and the substrate, or the GPS antenna and the substrate are disposed on the two opposite sides of the circuit board such that the GPS antenna will not be interfered or affected by the substrate.

The conductive member includes at least one ground strip extended from the conductive member and connected to the GPS antenna, or the conductive member includes an I-shaped construction.

The circuit board includes a first antenna device provided on the second side of the circuit board. The first antenna device may be selected from a double frequency antenna device ranged between 2.4 GHz and 5 GHz.

The circuit board includes a second antenna device provided on the second side of the circuit board. The second antenna device may also be selected from a double frequency antenna device ranged between 2.4 GHz and 5 GHz.

The circuit board includes a global system for mobile communications (GSM) antenna provided on the second side of the circuit board which may be selected from a four-frequency antenna GSM850/900/1800/1900 MHz. It is to be noted that the circuit board is disposed between the GPS antenna and the substrate, or the GPS antenna and the substrate are disposed on the two opposite sides of the circuit board such that the GPS antenna will not be interfered or affected by the antenna devices and the GSM antenna.

The circuit board includes an amplifier module provided on the second side of the circuit board and electrically connected to the GPS antenna.

The GPS antenna includes an antenna conductor and a feed extended from the antenna conductor and connected to the conductive member. The circuit board is preferably perpendicular to the substrate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an antenna assembly in accordance with the present invention as seen from the rear portion of the antenna assembly;

FIG. 2 is another partial exploded view of the antenna assembly as seen from the front portion of the antenna assembly;

FIG. 3 is a front perspective view of the antenna assembly;

FIG. 4 is another front perspective view illustrating the operation of the antenna assembly;

FIG. 5 is a perspective view illustrating the radiation field of the antenna assembly;

FIG. 6 is a plan schematic view illustrating the voltage standing wave ratio of the GPS antenna device of the antenna assembly;

FIG. 7 is another plan schematic view illustrating the voltage standing wave ratio of one of the antenna device of the antenna assembly;

FIG. 8 is a further plan schematic view illustrating the voltage standing wave ratio of the other antenna device of the antenna assembly; and

FIG. 9 is a still further plan schematic view illustrating the voltage standing wave ratio of the GSM antenna device of the antenna assembly.

### DETAILED DESCRIPTION OF THE PREFERRED EMBODIMENT

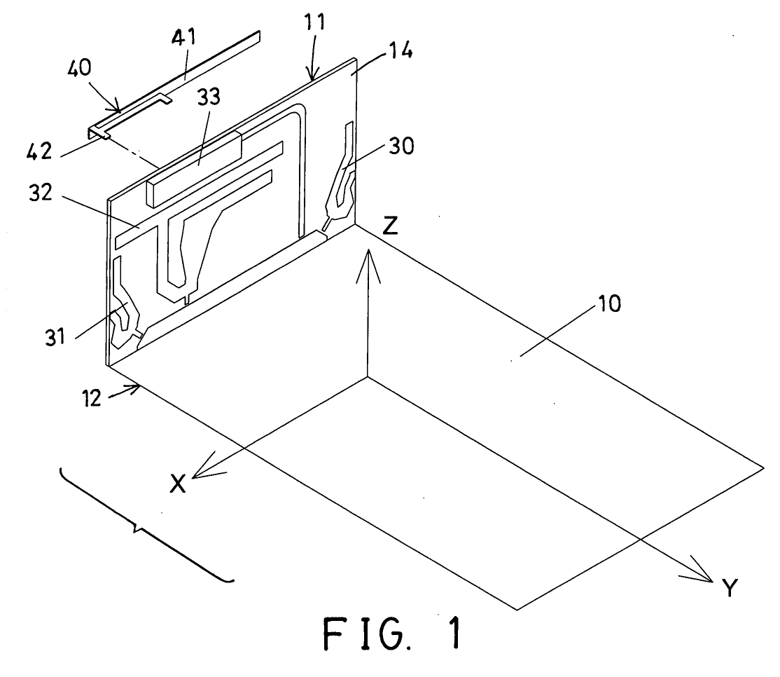

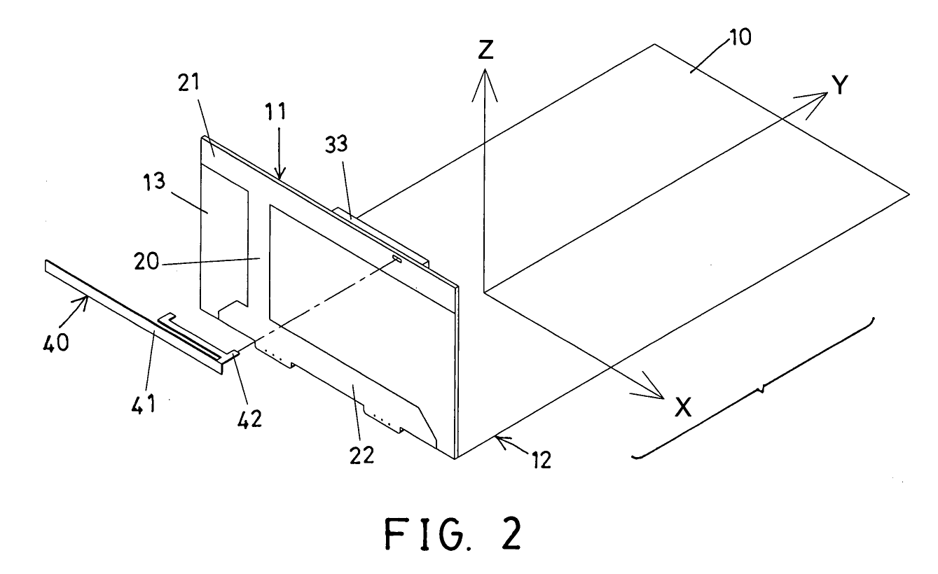

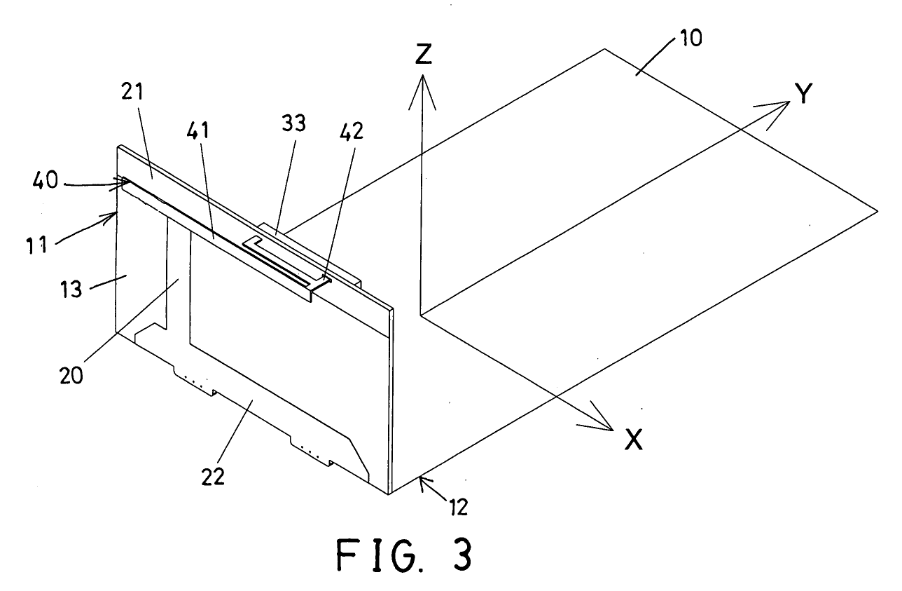

Referring to the drawings, and initially to FIGS. 1-3, an antenna assembly in accordance with the present invention comprises a circuit board or earth plate or substrate 10, and another substrate or circuit board 11 attached to or extended from one side or one end 12 of the substrate 10, and inclined or perpendicular to the substrate 10, the circuit board 11 includes a conductive member 20 provided or attached to or applied onto one side 13 of the circuit board 11 and having one or more (such as two) ground strips 21, 22 extended from the two ends of the conductive member 20 respectively for forming an I-shaped construction or conductive member 20.

As shown in FIG. 1, the circuit board 11 includes one or more (such as two) antenna devices 30, 31 provided or attached to or applied onto the other side 14 of the circuit board 11, and the antenna devices 30, 31 may be selected from various antenna devices, such as the 2.4 GHz and 5 GHz double frequency antenna devices, and includes a global system for mobile communications (GSM) antenna 32 which may be selected from the four-frequency antenna GSM850/900/1800/1900 MHz, for example. The circuit board 11 may further include a low pass or low noise amplifier module 33 provided or attached to the other side 14 of the circuit board 11.

The antenna assembly in accordance with the present invention further comprises a global position system (GPS) antenna 40 formed by hammered or forged metal members and including an antenna conductor 41 and a feed 42 extended from the antenna conductor 41 and connected or coupled to one of the ground strips 21 of the conductive member 20, and also connected or coupled to the amplifier module 33 for transmitting or receiving waves or signals, and for allowing the GPS antenna 40 and the substrate 10 and the antenna devices 30, 31 and the GSM antenna 32 to be disposed on the two opposite sides of the circuit board 11.

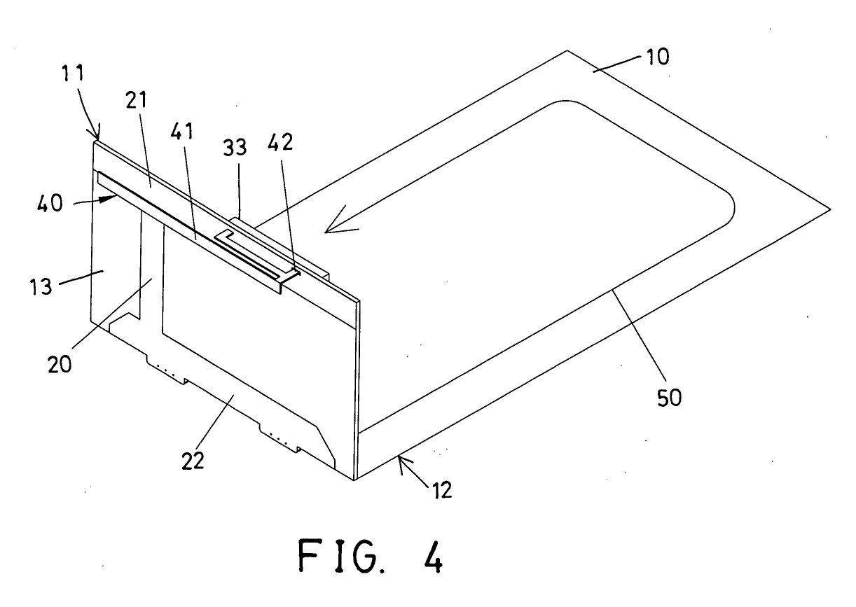

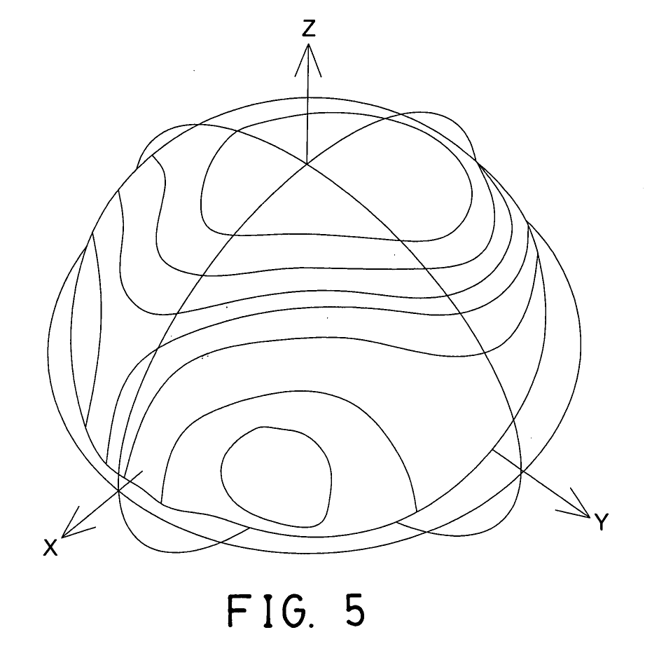

In operation, as shown in FIG. 4, when a radio frequency current 50 is generated and flown in or on the substrate 10, the resonant current generated by the GPS antenna 40 will not be interfered or affected or attracted by the radio frequency current 50 provided or formed on the substrate 10 such that the radiation field generated by the antenna conductor 41 of the GPS antenna 40 may be suitably formed and directed toward various directions as shown in FIG. 5 and such that the signal transmitting and receiving functions of the antenna conductor 41 of the GPS antenna 40 may be suitably increased or facilitated.

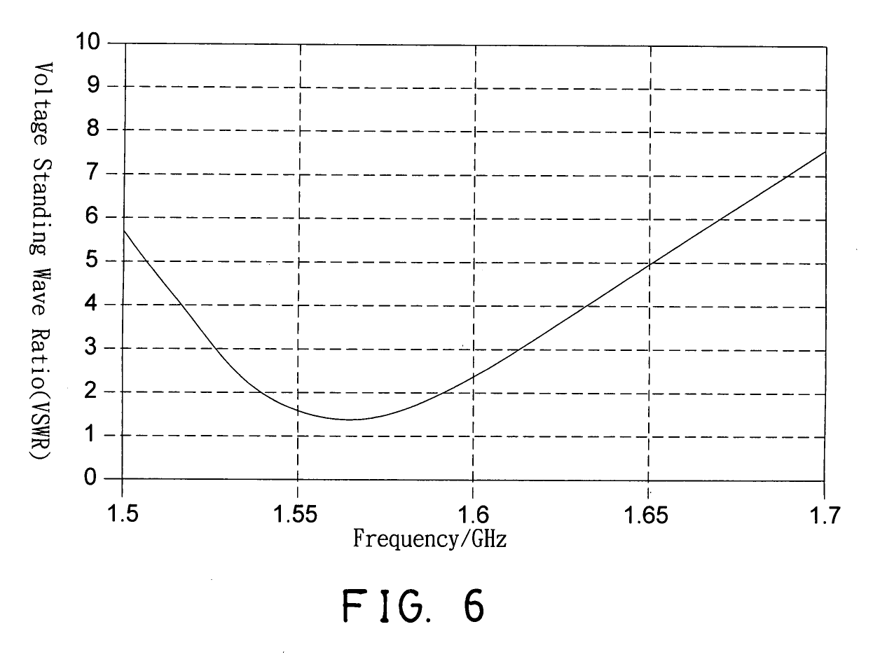

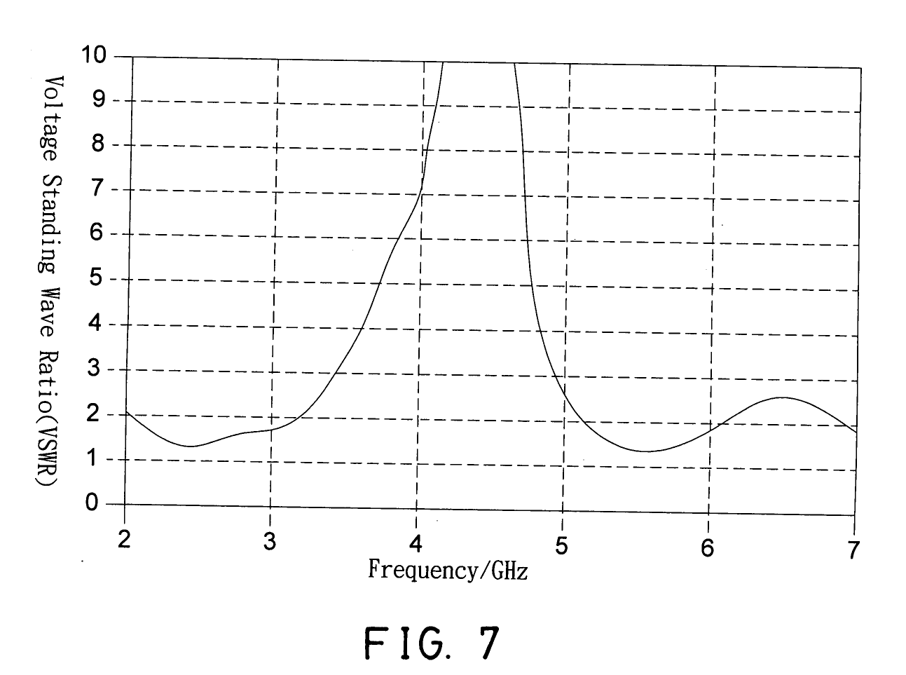

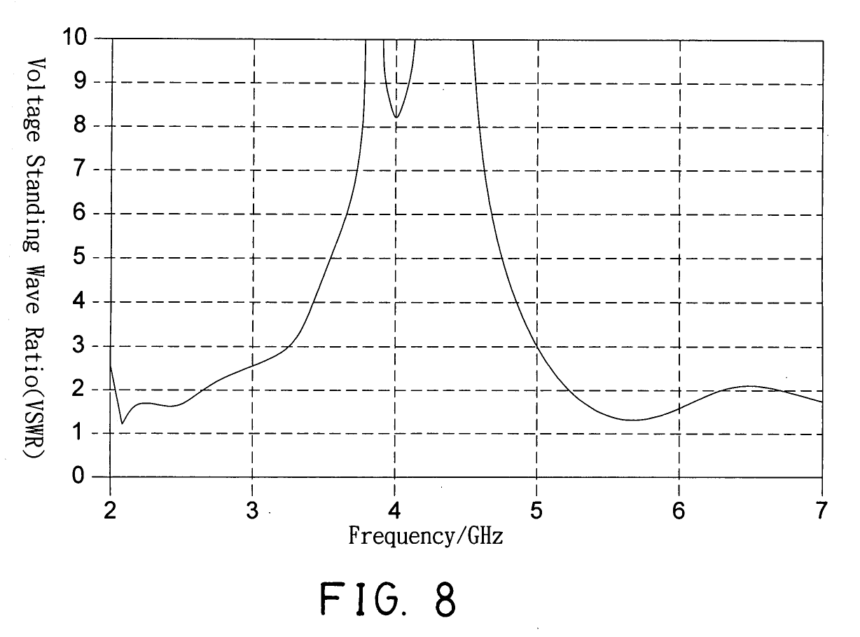

As shown in FIG. 1, the antenna devices 30, 31 and the GSM antenna 32 include different resonant paths, and the GPS antenna 40 is connected or coupled to the low pass or low noise amplifier module 33 such that the antenna assembly in accordance with the present invention may be used or worked with various different frequencies. For example, as shown in FIG. 6, the working frequency of the GPS antenna 40 may be ranged around 1.5 GHz, as shown in FIG. 7, the working frequency of one of the antenna devices 30 may be ranged between 2.4 GHz and 5 GHz, and also may be ranged between 5.15 GHz and 5.85 GHz, as shown in FIG. 8, the working frequency of the other antenna device 31 may also be ranged between 2.4 GHz and 5 GHz, and also may be ranged between 5.15 GHz and 5.85 GHz.

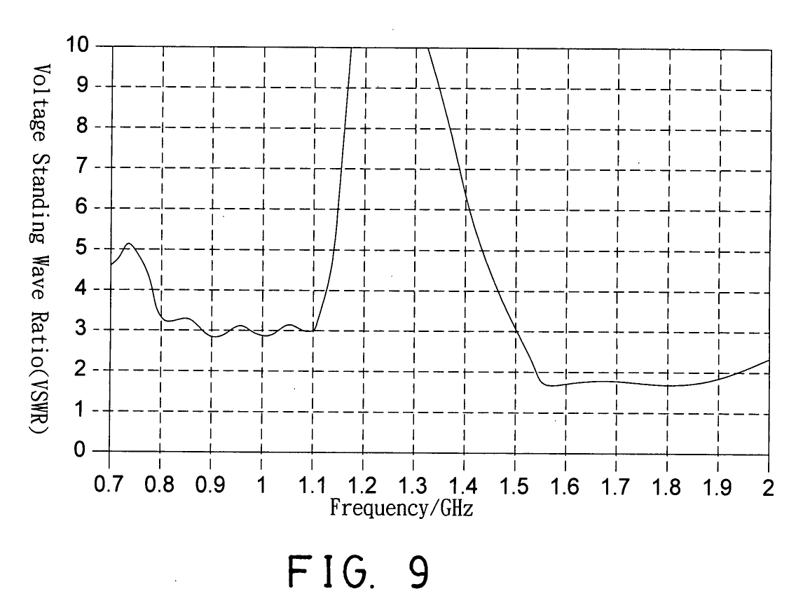

As shown in FIG. 9, the working frequency of the GSM antenna 32 may be ranged between 0.824 GHz and 0.96 GHz, and also may be ranged between 1.7 GHz and 1.9 GHz, such that the antenna assembly in accordance with the present invention may be suitably used or worked with various different frequencies and the gain of the antenna assembly may be suitably increased. It is to be noted that the circuit board 11 is disposed between the GPS antenna 40 and the substrate 10, or the GPS antenna 40 and the substrate 10 are disposed on the two opposite sides of the circuit board 11 such that the GPS antenna 40 will not be interfered or affected by the antenna devices 30, 31 and the GSM antenna 32.

Accordingly, the antenna assembly in accordance with the present invention includes a structure for allowing the antenna assembly to suitably transmit and receive the signals and for increasing the gain of the antenna assembly, and for preventing the GPS antenna and the antenna devices and the GSM antenna that are disposed on two opposite sides of the circuit board from being interfered or affected by each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna assembly comprising:
a circuit board including a first side and a second side,
a substrate extended from said second side of said circuit board,
a conductive member provided said first side of said circuit board, and
a GPS antenna connected to said conductive member of said circuit board and arranged opposite to said second side of said circuit board and said substrate.

2. The antenna assembly as claimed in claim 1, wherein said conductive member includes at least one ground strip extended from said conductive member and connected to said GPS antenna.

3. The antenna assembly as claimed in claim 1, wherein said conductive member includes an I-shaped construction.

4. The antenna assembly as claimed in claim 1, wherein said circuit board includes a first antenna device provided on said second side of said circuit board.

5. The antenna assembly as claimed in claim 4, wherein said first antenna device is selected from a double frequency antenna device ranged between 2.4 GHz and 5 GHz.

6. The antenna assembly as claimed in claim 4, wherein said circuit board includes a second antenna device provided on said second side of said circuit board.

7. The antenna assembly as claimed in claim 6, wherein said second antenna device is selected from a double frequency antenna device ranged between 2.4 GHz and 5 GHz.

8. The antenna assembly as claimed in claim 1, wherein said circuit board includes a GSM antenna provided on said second side of said circuit board.

9. The antenna assembly as claimed in claim 8, wherein said GSM antenna is selected from a four-frequency antenna GSM850/900/1800/1900 MHz.

10. The antenna assembly as claimed in claim 1, wherein said circuit board includes an amplifier module provided on said second side of said circuit board and connected to said GPS antenna.

11. The antenna assembly as claimed in claim 1, wherein said GPS antenna includes an antenna conductor and a feed extended from said antenna conductor and connected to said conductive member.

12. The antenna assembly as claimed in claim 1, wherein said circuit board is perpendicular to said substrate.
